(19) United States
(12) Patent Application Publication
(10) Pub. No.: US 2022/0069356 A1
(43) Pub. Date: Mar. 3, 2022

(54) BATTERY AND A METHOD FOR FITTING A ELECTROLYTE-CONTAINING SOLID MEDIUM TO AN ELECTRODE IN THE BATTERY

(71) Applicant: CITY UNIVERSITY OF HONG KONG, Kowloon (HK)

(72) Inventors: Chunyi ZHI, Shatin (HK); Longtao MA, Kowloon (HK)

(21) Appl. No.: 17/409,302

(22) Filed: Aug. 23, 2021

Related U.S. Application Data
(60) Provisional application No. 63/071,519, filed on Aug. 28, 2020.

(51) Int. Cl. H01M 10/0585; H01M 4/38; H01M 10/0562

(52) U.S. Cl. CPC H01M 10/0585; H01M 2004/027; H01M 10/0562; H01M 4/38

(57) ABSTRACT

A method of fitting a electrolyte-containing solid medium to an electrode, comprising the steps of: providing a solution of at least one type of monomer in onto the electrode; the solution of at least one type of monomer containing an electrolyte; polymerising the monomer to create a polymeric matrix while the solution is on the electrode; wherein the polymeric matrix provide the electrolyte-containing solid medium. Typically, the monomer is 1,3-dioxolane; and the electrolyte is zinc tetrafluoroborate Zn(BF₄₎₂.

### FIELD OF INVENTION

The invention relates to solid state batteries. In particular, the invention relates to solid state batteries with improved contact between electrodes and a solid electrolyte.

### BACKGROUND OF THE INVENTION

Batteries that contain liquids are unsuitable in some circumstances as they deteriorate in alarming ways. Sometimes, the acids in the batteries may leak and corrode the device in which they are installed. Other times, the batteries can build up an internal pressure, and expand in size or deform. It has not been unheard of that batteries explode and cause fires. However, the liquid portions in such batteries are crucial for movements of electrolytes between the electrodes to provide a current.

It has been proposed that batteries can be made without liquid. In this kind of batteries, the electrolyte is embedded in a solid matrix that allows a current to flow. The solid matrix contacts both the anode and the cathode. The solid matrix can be made of ceramics (e.g., oxides, sulfides, phosphates) or solid polymers. These batteries are called solid-state batteries, and have found use in pacemakers, RFID and wearable devices, i.e. anything in which liquid leak and battery expansion is not acceptable. Solid state batteries are potentially safer than batteries with liquid electrolyte solutions.

However, while a liquid can flow over uneven profile of any surface into full contact with the surface, such that even the deep ends of every tiny fissure in the surface may come into contact with the liquid, such contact is not possible between two pre-fabricated solid parts. That is, a solid electrolyte matrix is unable to be pressed to deform into a shape that fills the profile of an electrode surface to achieve full contact, especially when the electrode surface is rough and uneven. This is why miniscule gaps between two solids will always exist, as solid surfaces are always uneven on the microscopic and nanoscale levels. Hence, solid state batteries have been unable to overtake the conventional “liquid state” batteries in terms of quality due to gaps in the contact between electrode and electrolyte.

It is therefore desirable to propose a method and/or a device which can litigate or improve the contact efficiency or completeness between electrolyte and electrodes.

### STATEMENT OF INVENTION

In a first aspect, the invention proposes a method of fitting a electrolyte-containing solid medium to an electrode, comprising the steps of: providing a solution of at least one type of monomer in onto the electrode; the solution of at least one type of monomer containing an electrolyte; polymerising the monomer to create a polymeric matrix while the solution is on the electrode; wherein the polymeric matrix provide the electrolyte-containing solid medium.

Therefore, the invention provides the possibility of polymerising a monomer in situ, i.e. on the electrode. This provides a physical, solid state electrolyte that has is formed with a shape that conforms any unevenness or crevices on the surface of the electrode. The contact between the electrode and electrolyte is thereby maximised.

Typically, the monomer is 1,3-dioxolane; and the electrolyte is zinc tetrafluoroborate Zn(BF₄)₂. The polymer formed of this monomer encapsulating the electrolyte is particularly suited for a stable, solid state electrolyte.

Preferably, the method further comprises the step of adding an aluminium salt to provide Al³⁺ in the solution of monomers. Where the monomer is 1,3-dioxolane, polymerization can be triggered by opening the ring in 1,3-dioxolane, initiated by the Al³⁺. Alternatively, in other possible embodiments, other suitable ions that can trigger the ring opening in 1,3-dioxolane may be used.

Typically, the solution contains 4M Zn(BF₄₎₂/DOL (electrolyte/monomer), and 2 mM AlOTf.

In a further aspect, the invention proposes a solid state battery comprising two electrodes in contact with a polymeric matrix; the polymeric matrix embedded with an electrolyte; the polymeric matrix shares an interface with the at least one of the two electrodes that is formed by a process of polymerising the solution of monomers when the solution is in contact with the anode.

Typically, the two electrodes in contact with a polymeric matrix; the polymeric matrix embedded with an electrolyte; the polymeric matrix shares an interface with the at least one of the two electrodes that is formed by a process of polymerising the solution of monomers when the solution is in contact with the anode.

Typically, the electrolyte is a zinc salt, and the anode is zinc. This provides a zinc half-cell. However, other kinds of half cells instead of zinc is possible, such copper being the electrode and matched with a copper salt embedded in a polymeric matrix to provide a copper half-cell.

Preferably, the monomer is 1,3-dioxolane; and the electrolyte is zinc tetrafluoroborate Zn(BF₄₎₂.

In some embodiments, the two electrodes form a plane; and the polymeric matrix form another plane; wherein the plane of the polymeric matrix is laid on the plane formed by the two electrodes. Alternatively, the polymeric matrix has two sides; one of the two electrodes contacting one of the two sides; and the other one of the two electrodes contacting the other one of the two sides.

Typically, the polymeric matrix is flexible; and each of the two electrodes is flexible. Alternatively, it is possible in some other embodiments that the polymeric matrix is not flexible but rigid.

### BRIEF DESCRIPTION OF THE FIGURES

It will be convenient to further describe the present invention with respect to the accompanying drawings that illustrate possible arrangements of the invention, in which like integers refer to like parts. Other arrangements of the invention are possible, and consequently the particularity of the accompanying drawings is not to be understood as superseding the generality of the preceding description of the invention.

FIG. 1 shows a battery which is a first embodiment of the invention;

FIG. 2 shows the embodiment of FIG. 1 used in a closed circuit;

FIG. 3 shows a part of the electrodes of the embodiment of FIG. 1;

FIG. 4 shows schematically how solid state electrolyte is applied to one of the electrodes of the battery of FIG. 1;

FIG. 5 shows schematically a comparative prior art to the embodiment of FIG. 1;

FIG. 6 shows the scanning electron microscope images of the interface between the zinc electrode and the SPE;

FIG. 7 shows another embodiment in which the monomer solution is applied onto a zinc anode 201 and also a CoHCF cathode;

FIG. 8 illustrates yet another embodiment which is similar to that described with FIG. 7;

FIG. 9a is a picture of a prototype of the embodiment of FIG. 8;

FIG. 9b shows pictures which indicate that the polymerization to produce the polymer used in the embodiment of FIG. 1 has taken place; and

FIG. 10 illustrates the polymerization reaction of 1,3-dioxolane.

### DETAILED DESCRIPTION OF EMBODIMENTS

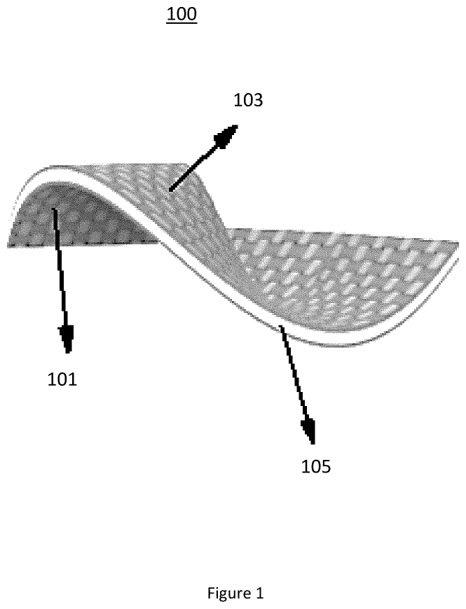

FIG. 1 shows a first embodiment of the invention, which is a flexible Zn-cobalt ferricyanide battery 100.

The battery 100 is formed of two flexible electrodes, one being a zinc anode 101 and the other being CoHCF (cobalt hexacyanoferrate) cathode 103. Sandwiched between the two electrodes is a layer of solid polymeric electrolyte (SPE) 105. The solid polymeric electrolyte is made of a polymer that is flexible.

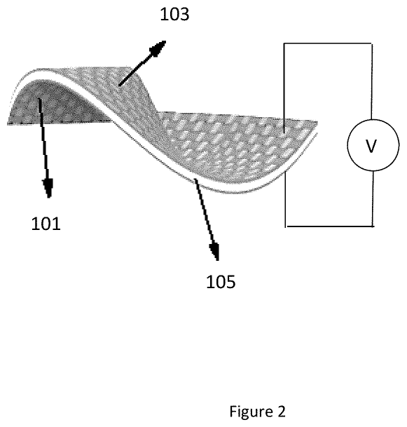

The solid polymeric electrolyte can be placed between the zinc anode and the CoHCF cathode to provide a battery in the form of a three-layered flexible fabric. The flexible solid battery can be used in garments or as wrapping around a device to provide a source of electricity without taking up space that must have a pre-defined shape like with conventional batteries. The zinc anode and the CoHCF cathode need only be connected to a load to provide a closed circuit to supply power to the load, as illustrated in FIG. 2.

The solid polymeric electrolyte is made of a polymeric matrix that is embedded with a salt of zinc, and this completes the half-cell at the zinc anode. However, the interface between the zinc anode and the solid polymeric electrolyte must be as seamless as possible for current flow to be optimal. Having optimised current flow also allows for device performance to be characterised, calculated and for stringent quality control to be applied, because the randomness in current flow efficiency is reduced thereby.

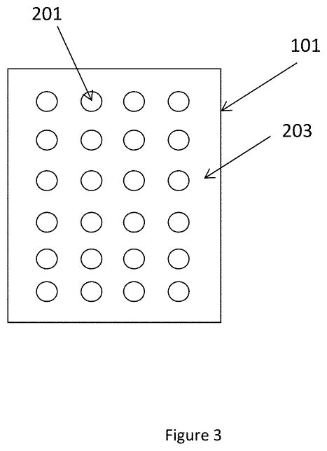

By calling it flexible, it means herein that battery has the features of one or all of being bendable, rollable, foldable or stretchable. In this case, the electrodes on both sides of the battery can be subject to repeated deformation stress. To provide that the electrodes are flexible and may be deformed along with the solid polymeric electrolyte, the electrodes are preferably riveted, woven into or otherwise embedded into flexible materials that act as current collectors. Current collectors refer to electrical conductors between an electrode and the external circuit, and may provide physical support for the electrode materials. In this case, as shown in FIG. 3, pieces of zinc 201 providing the anode is riveted into a piece of carbon cloth fibre (CFC) 203, where the carbon cloth is the carbon collector. The size of these pieces of zinc is very small so that the flexibility and fold-ability of the fabric is not affected. Preferably, the loading mass of the carbon cloth filter is 3 to 8 mg/cm². Other examples of materials that can be used a carbon collectors include carbon nanotube paper, carbon cloth, carbon paper, nickel foam, or even a steel sheet.

Similarly, pieces of CoHCF for the cathode is also woven or riveted into a layer of carbon cloth fibre or other similar materials (not illustrated).

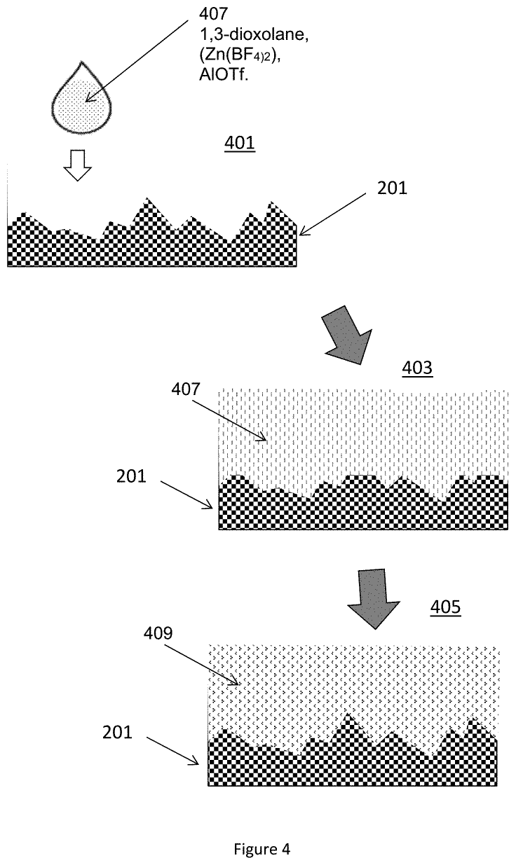

FIG. 4 shows schematically how the interface between the elemental zinc 201 electrode and the layer of solid polymeric matrix may be provided such that there is gap therebetween. In order to provide the tight fit between the zinc electrode and the solid polymeric electrolyte, the solid polymeric electrolyte is polymerized from a liquid solution 407 of the required monomer in situ, on the zinc anode. That is, the monomer solution 407 is poured onto the zinc anode first, at stage 401. As a liquid, the solution is able to flow into every tiny crevice and fissure on the surface of the zinc anode, at stage 403. Therefore, when the monomers link up during a process of polymerisation into a polymer 409, at stage 405, the resultant polymer 409 will have filled up all the crevices and fissures on the surface of the zinc anode. This creates a virtually seamless or fully contacting interface between the zinc anode and the polymer, which increases the efficiency of current passage in the solid state battery.

In a preferred embodiment, the monomer 407 solutions contains 1,3-dioxolane and Zn(BF₄₎₂. When the 1,3-dioxolane (DOL) polymerises, the resulting polymer (polyDOL) becomes a solid matrix that is embedded with Zn(BF₄₎₂.

The polymeric structure of polyDOL provides well-connected pathways for Zn²⁺ ionic transport. There is virtually no resistance due to non-contact interface with the electrodes as the polymer is polymerised in situ on the electrodes, which also provides excellent mechanical robustness and non-dry properties.

Typically, the interfacial contact can be characterized by ripping both electrodes from solid polymeric electrolyte, and the interfacial resistances can be characterized by conducting electrochemical impedance of battery with bending angles varying from 30° to 180° and after 2000 bending cycles with fixed 120° bending angle.

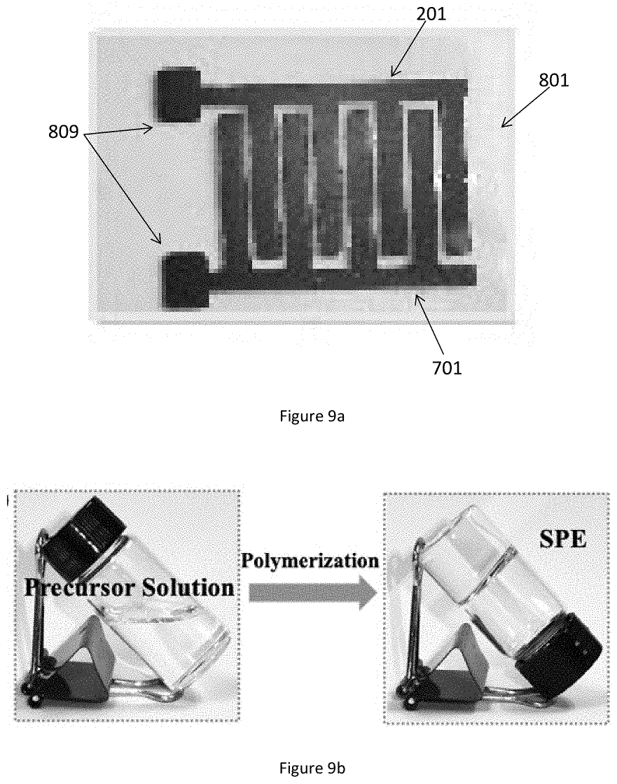

Accordingly, a solid polymeric electrolyte has been described. The solid polymeric electrolyte is polymerised in-situ as an amorphous solid polymer. Experiments have shown that the solid polymeric electrode exhibits high Zn ion conductivity of 19.6 mS·cm⁻¹ at room temperature, low interfacial impedance, highly reversible Zn plating/stripping over 1800 h cycles, uniform & dendrite-free Zn deposition, and non-dry properties. The in-plane interdigital-structure embodiment as shown in FIG. 9a with electrolyte completely exposed to open atmosphere can be stably operated for over 30 days almost without weight loss and electrochemical performance decay. Furthermore, the sandwich-structure embodiment as shown in FIG. 1 can normally operate over 40 min under fire condition. These results far outperform that of hydrogel electrolyte-based batteries, in which the capacity retained is lower than 50% after 5 days in open atmosphere or 5 min under fire condition. The interfacial impedance and capacity of in-situ-formed solid polymeric electrode has been observed to be capable of remaining almost unchanged after various bending tests, which fulfils a key criterion for flexible/wearable devices. Therefore, the embodiments embody an approach of making solid state electrolytes that could fulfil requirements of no-liquid, mechanical robustness for practical solid-state Zn batteries.

Advantageously, the solid polymeric electrolyte is capable of being used with high Zn²⁺ transference number of 0.7, which is much better than with those of prior art aqueous Zn-based electrolyte (with transference number of only 0.2-0.4) and even an acetamide/Zn(TFSI)₂ eutectic electrolyte (transference number of 0.57). The high Zn²⁺ transference numbers in the polymer originate from interaction of H atoms in the polyDOL long chains with F atoms in BF₄⁻anions to form H . . . F hydrogen bonds, which thus hinder the movement of the BF₄⁻ anions. On the other hand, the active Zn²⁺ ion motion manner in solid polymeric electrolytes differs from those observed in conventional electrolytes, which obey underlying rafting-type ion transport mechanisms. The solid polymeric electrolytes as described demonstrate a potential approach for the making of solid-state Zn batteries.

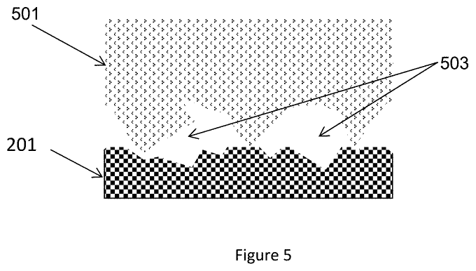

FIG. 5 shows schematically a comparative prior art, in which the solid polymeric electrolyte 501 is polymerised away from the zinc electrode, ex situ, and then put onto the zinc electrode thereafter. In this case, the interface between the zinc electrode and a layer of solid polymeric matrix has gaps 503 at the nano-scopic level, which reduces the effectiveness of current flow. This is because the surface of the zinc electrode is uneven at the nano-scopic level, and so is the surface of the polymeric matrix, and the uneven surfaces are created naturally and randomly and cannot be made to fit one into the other. Hence, the contact between the zinc electrode and the polymeric matrix is not optimal.

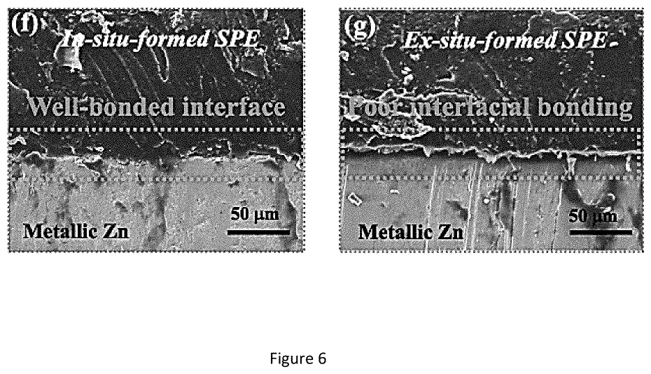

FIG. 6 shows the scanning electron microscope images of the interface between the zinc electrode and the solid polymeric electrolyte according to the embodiment (left image), and the interface between the zinc electrode and the solid polymeric electrolyte which is the prior art (right image). That is, the solid polymeric electrolyte was polymerised in situ on the zinc layer in the left image, and corresponds to the illustration in FIG. 4. In the right image, the solid polymeric electrolyte was polymerised elsewhere before being placed onto the zinc layer, which suffers from gaps in the interface, and corresponds to the illustration in FIG. 5.

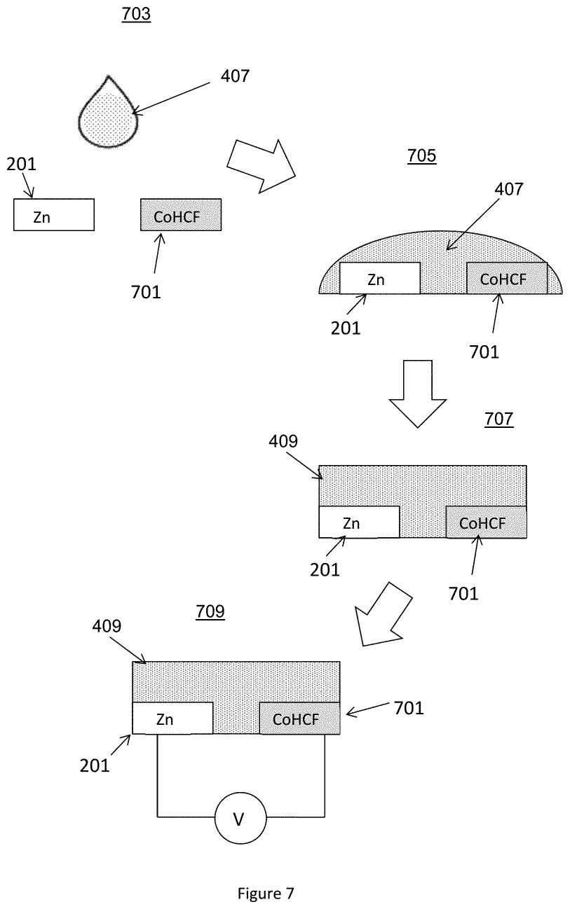

As the solid polymeric electrolyte contains a zinc electrolyte, it is possible in some embodiments that the in situ polymerization is only used to connect the resultant solid polymeric electrolyte to a zinc anode. In contrast, however, FIG. 7 shows another embodiment in which the monomer solution is applied onto a zinc anode 201 and also a CoHCF cathode 701, at stage 703, in such a way that that the monomer solution covers over both the electrodes 201, 701, at stage 705. When the solution of monomers polymerises, the resulting solid polymeric electrolyte covers over both the electrodes, at stage 707. The electrodes are exposed on the side that is not covered over by the solid polymeric electrolyte for the application of a load, at stage 709. In this embodiment, as the monomer solution is able to seep into all the fissures and uneven profile on the surface of each of the electrodes, the interface between each of both electrodes and the solid polymeric electrolyte is also virtually without gap and contact is practically optimal.

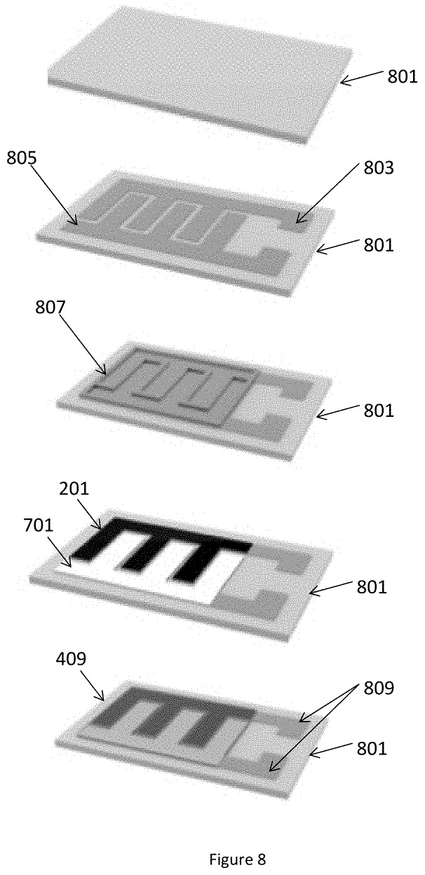

FIG. 8 illustrates yet another embodiment which is similar to that described with FIG. 7. In FIG. 8, a substrate 801 is first supplied. The substrate 801 is firstly etched to create two wells 803, 805. An insulating material 807 is then printed around the edge of the two wells to ensure the materials forming the two electrodes do not contact each other. A layer of zinc 201, which may be zinc powder or a film of zinc is used to fill one of the wells to provide an anode 201. Subsequently, the other well is filled with CoHCF 701 to provide the cathode. Subsequently, the monomer solution 407 as aforedescribed is applied (not illustrated) to cover over both electrodes and allowed to polymerize while in contact with both electrodes. This creates a solid polymeric electrolyte 409 which has a gap-less contact with both electrodes.

As can be seen in FIG. 8, the extreme ends 809 of each well is left unfilled for the purpose of accommodating connections to any kind of suitable load to close the circuit.

FIG. 9a is a picture of an actual prototype of the embodiment of FIG. 8. The polymerised 1,3-dioxolane, i.e. poly(1,3-dioxolane), is a transparent amorphous polymer and, therefore, the electrodes can be seen though the polymer. The polymerisation reaction is initiated by cationic Al³⁺ species in the liquid Zn(BF₄)₂/DOL electrolyte, in which the cationic Al³⁺ first attaches oxygen atom and initiates the ring-opening polymerization. FIG. 9b shows on the left picture the monomer solution, and on the right picture the polymer after polymerisation. The polymer is a transparent, amorphous solid that remains on the bottom of the vial in the picture despite being turned upside down. The degree of crystallinity of a polymer electrolyte matrix impacts ion mobility and the transport rate. Hence, the amorphous nature of the polymer as seen by the transparency promotes greater percolation of charge. It follows that a key parameter of transport is the temperature dependency of polymer morphology on transport mechanisms by the glass transition temperature, typically.

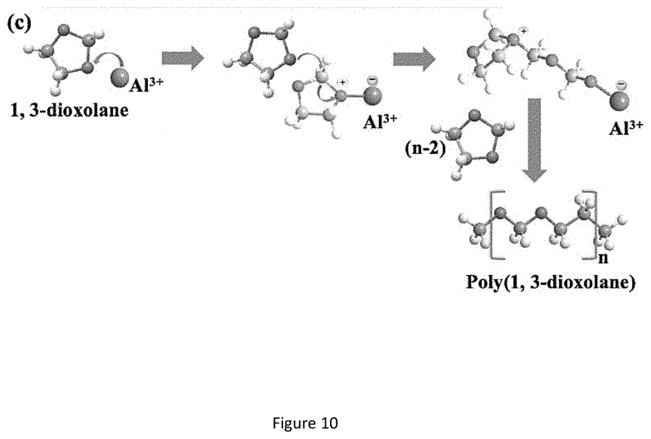

FIG. 10 illustrates the polymerization reaction of 1,3-dioxolane. To initiate the reaction, an aluminium ion is supplied into the monomer solution. Hence, a trace amount of aluminium is always found in the final polymer. The reaction is initiated by cationic Al³⁺ species in the liquid Zn(BF₄₎₂/dioxolane electrolyte, in which the cationic Al³⁺ first attaches to an oxygen atom and initiates the ring-opening polymerization. The resultant solid polymeric electrolyte doesn't contain any liquid and polydioxolane provides a matrix for encapsulating the electrolyte. The zinc salt in the solution is thereby encapsulated inside the polymer in this way.

Typically, the dioxolane precursor solution 407 comprises a zinc salt and an aluminium salt, wherein the zinc salt solution has a concentration of 0.2-4.0M and the aluminium salt is at a concentration of none to 5 mM. In the preferred embodiment, however, the solution 407 comprises 4 M of Zn(BF₄₎₂ and 2 mM of dioxolane electrolyte, and 2 mM of Al(OTf)₃ additive.

In some experiments, it has been observed that the ionic conductivity of solid polymeric electrolytes with 4 M Zn(BF₄₎₂ and 2 mM Al(OTf)₃ salts declines during the first 5 hours after initiating the ring-open polymerization and reaches a constant value over longer durations, indicating complete polymerization after 5 hours.

Accordingly, the described embodiments include an in-situ-formed solid polymeric electrolyte comprising: (a). the in-situ poly(1,3-dioxolane, DOL); (b). zinc tetrafluoroborate Zn(BF₄₎₂ salts to provide Zn²⁺ ions. The polymerisation is initiated using aluminum trifluoromethanesulfonate (Al(OTf)₃) salts as initiator.

While there has been described in the foregoing description preferred embodiments of the present invention, it will be understood by those skilled in the technology concerned that many variations or modifications in details of design, construction or operation may be made without departing from the scope of the present invention as claimed.

For example, besides a polymer derived from the polymerization of 1,3dioxolane, other polymers such as polytetrahydrofuran electrolyte, poly(ethylene oxide) electrolyte and so on are within the contemplation of this application.

1. A method of fitting a electrolyte-containing solid medium to an electrode, comprising the steps of:
providing a solution of at least one type of monomer in onto the electrode;
the solution of at least one type of monomer containing an electrolyte;
polymerising the monomer to create a polymeric matrix while the solution is on the electrode; wherein
the polymeric matrix provide the electrolyte-containing solid medium.

2. A method of fitting a electrolyte-containing solid medium to an electrode, as claimed in claim 1, wherein
the monomer is 1,3-dioxolane; and
the electrolyte is zinc tetrafluoroborate Zn(BF₄₎₂.

3. A method of fitting a electrolyte-containing solid medium to an electrode as claimed in claim 1, further comprising the step of:
adding an aluminium salt to provide Al³⁺ in the solution of monomers.

4. A method of fitting a electrolyte-containing solid medium to an electrode as claimed in claim 3, wherein
the solution contains 4M Zn(BF₄₎₂/DOL (electrolyte/monomer), and 2 mM AlOTf.

5. A solid state battery comprising:
two electrodes in contact with a polymeric matrix;
the polymeric matrix embedded with an electrolyte;
the polymeric matrix shares an interface with the at least one of the two electrodes that is formed by a process of polymerising the solution of monomers when the solution is in contact with the anode.

6. A solid state battery as claimed in claim 5, wherein
two electrodes in contact with a polymeric matrix;
the polymeric matrix embedded with an electrolyte;
the polymeric matrix shares an interface with the at least one of the two electrodes that is formed by a process of polymerising the solution of monomers when the solution is in contact with the anode.

7. A solid state battery as claimed in claim 5, wherein
the electrolyte is a zinc salt; and
the anode is zinc.

8. A solid state battery as claimed in claim 5, wherein
the monomer is 1,3-dioxolane; and
the electrolyte is zinc tetrafluoroborate Zn(BF₄₎₂.

9. A solid state battery as claimed in claim 5, wherein
the two electrodes form a plane; and
the polymeric matrix form another plane; wherein
the plane of the polymeric matrix is laid on the plane formed by the two electrodes.

10. A solid state battery as claimed in claim 5, wherein
the polymeric matrix has two sides;
one of the two electrodes contacting one of the two sides; and
the other one of the two electrodes contacting the other one of the two sides.

11. A solid state battery as claimed in claim 5, wherein
the polymeric matrix is flexible; and
each of the two electrodes is flexible.
